(19) United States
(12) Patent Application Publication
(10) Pub. No.: US 2013/0021154 A1
(43) Pub. Date: Jan. 24, 2013

(54) MEDICAL PARAMETERS NOTIFICATION SYSTEM

(71) Applicants: Clifford T. Solomon, Severna Park, MD (US); Theodore C. Solomon, Hampstead, MD (US)

(72) Inventors: Clifford T. Solomon, Severna Park, MD (US); Theodore C. Solomon, Hampstead, MD (US)

(21) Appl. No.: 13/556,152

(22) Filed: Jul. 23, 2012

Related U.S. Application Data
(60) Provisional application No. 61/510,427, filed on Jul. 21, 2011.

(51) Int. Cl. G08B 21/02; G08B 1/08

(52) U.S. Cl. 340/539.12

(57) ABSTRACT

The medical parameters notification system includes a portable device to be worn on the body by at least one adjustable connector. The portable device houses a control assembly for controlling data acquisition from a sensor cluster on the back side of the portable device and wirelessly transmits the data to an emergency response and/or monitoring station. The at least one adjustable connector is configured to insure consistent contact of the sensor cluster with the wearer's skin. A display is disposed on one side of the portable device to show select information and messages. In the event of an emergency, the medical parameters notification system automatically notifies an emergency response and/or monitoring station along with transmission of biometric data. Any false alarms can be cancelled, before transmission, by a selectively operable button on the portable device, which also serves to operate different functions of the system.

### CROSS-REFERENCE TO RELATED APPLICATION

This application claims the benefit of U.S. Provisional Patent Application Serial No. 61/1510,427, filed Jul. 21, 2011.

### BACKGROUND OF THE INVENTION

1. Field of the Invention

The present invention relates to medical devices, and particularly to a medical parameters notification system for remote monitoring and automatic notification of patient health status.

2. Description of the Related Art

Many elderly and the infirm may not be able to enjoy life to the fullest due to potential health issues. In most eases, these individuals suffer from chronic illnesses or deteriorating health due to old age. Their condition often prevents them from being able to travel for errands or recreation without supervision from a caretaker. Moreover, some care and monitoring must be exercised in their daily activities so as to prevent aggravation to their current health condition.

One solution to this dilemma has been a portable alert system worn by the patient or elderly that can automatically or manually alert emergency personnel upon detection of emergency conditions. However, in certain situations such as a severe fall or incapacitating injury, the user may not be capable of activating the device to notify emergency personnel. Moreover, the alert system usually does not have any means of constantly monitoring the user or patient whereby preventive measures may be taken prior to an emergency.

In light of the above, it would be a benefit in the health care arts to provide a monitoring/alert system that is capable of both automatic and remote emergency notification as well as more constant monitoring of health status, Thus, a medical parameters notification system solving the aforementioned problems is desired.

### SUMMARY OF THE INVENTION

The medical parameters notification system includes a portable device to be worn on the body by at least one adjustable connector such as a strap, lanyard or the like. The portable device houses a control assembly for controlling data acquisition from a sensor cluster on the back side of the portable device and wirelessly transmits the data to an emergency response and/or monitoring station. The at least one adjustable strap is configured to insure consistent contact of the sensor cluster with the wearer's skin. A display is disposed on one side of the portable device to show select information and messages. In the event of an emergency, the medical parameters notification system automatically notifies an emergency response and/or monitoring station along with transmission of biometric data. Any false alarms can be cancelled, before transmission, by a selectively operable button on the portable device, which also serves to operate different functions of the system.

These and other features of the present invention will become readily apparent upon further review of the following specification and drawings.

### BRIEF DESCRIPTION OF THE DRAWINGS

FIG. 1 is an environmental, perspective view of a medical parameters notification system according to the present invention.

FIG. 2 is a rear view of the medical parameters notification system shown in Fig.

FIG. 3 is a perspective of an alternative medical parameters notification system according to the present invention.

FIG. 4 is an environmental perspective view of a further alternative medical parameters notification system according to the present invention.

FIG. 5 is a perspective view of a still further alternative medical parameters notification system according to the present invention.

FIG. 6 is a schematic diagram of the controls for a medical parameters notification system according to the present invention.

Similar reference characters denote corresponding features consistently throughout the attached drawings.

### DETAILED DESCRIPTION OF THE PREFERRED EMBODIMENTS

The medical parameters notification system, generally referred to at 10 in the Figures, includes a portable device adapted to be worn by the user in a comfortable manner with sensors and controls for constant monitoring of the user's biometric parameters. The data from the sensors can be automatically transmitted to a remote monitoring system and may be used to diagnose any potential health problems, which allows the physician or health care provider to take corrective and/or preventive measures in a timely manner.

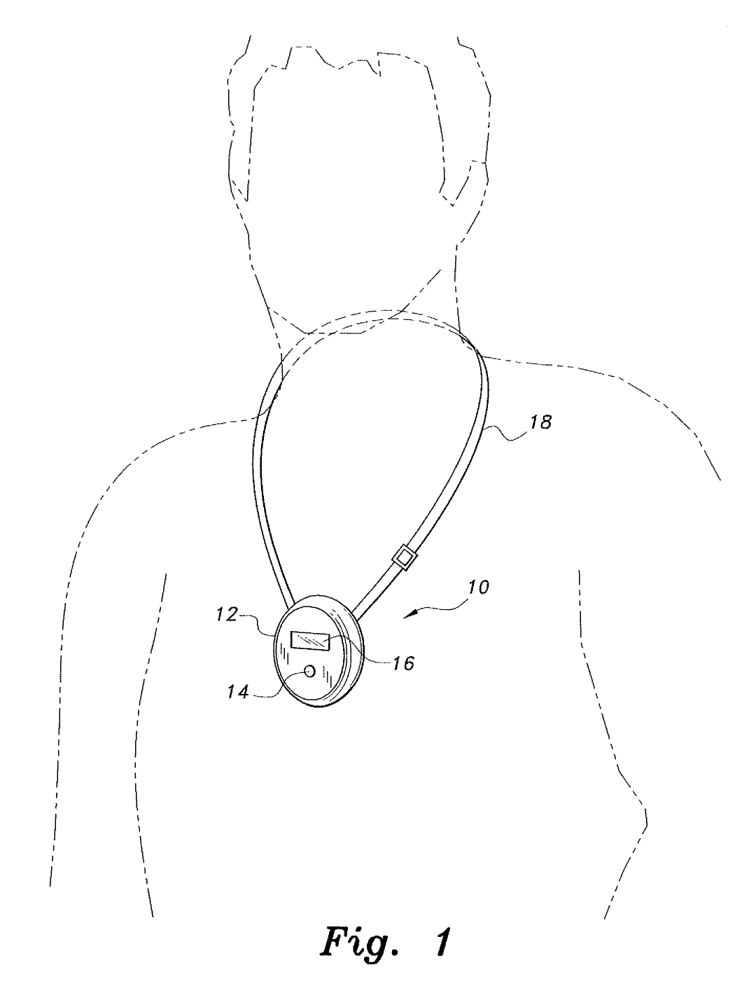

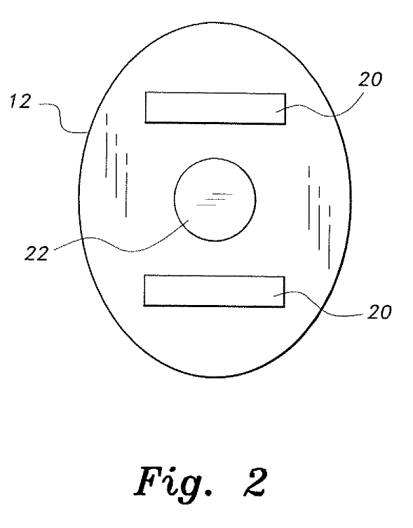

As shown in FIGS. 1 and 2, the medical parameters notification system 10 includes a portable device that can be provided in the form of a medallion or locket 12 adapted to he worn on the body of the wearer. In this embodiment, the medallion 12 is preferably hung around the neck of the user by an adjustable connector such as a strap or lanyard 18. The strap 18 can be secured by any type of adjustable strap fastener such as a hook and loop fastener, buckles, snap-fit fastener, etc. It is to be understood that the strap 18 may be of any size and length that can be adjusted for comfortable fit.

The medallion 12 is preferably a housing that holds a control assembly 30 therein. In a non-limiting exemplary embodiment, the medallion is preferably water resistant or watertight so that the medical parameters notification system 10 can be worn while the wearer showers or bathes. The control assembly 30 performs various functions such as sensing biometric data and notification, the details of which will be discussed below. The medallion 12 can include a display 16 showing pertinent information for the user. The displayed information may include time, alarms, rate of sampling, power status, and data transmission functions, all these being controlled by the control assembly 30 contained within the medallion 12. Preferably, the display 16 may be a monochromatic or colored LCD (liquid crystal display) due to the relative low expense and ease of manufacture for these types of displays. However, any type of electronic display capable of showing alphanumeric characters, symbols and/or graphics may also be used. Analog and/mechanical displays are alternative displays, but they would be limited in the types of information that can be shown.

At least one button 14 is disposed on the surface of the medallion 12 and preferably disposed adjacent the display 16. The location of the button 14 should be within easy reach by the wearer. The button 14 is selectively operable by the user, mainly during emergency situations. For example, if the user is incapacitated due to a heart attack or suffering from some other physical duress, the user may press the button 14 to notify an emergency response team that help is required. Selective button presses and/or combinations may also be used to power the medical parameters notification system 10 ON/OFF or for selecting different functions. If the user is not physically capable of actuating the button 14, the control assembly 30 is configured to automatically transmit an emergency signal after a predetermined brief period of time.

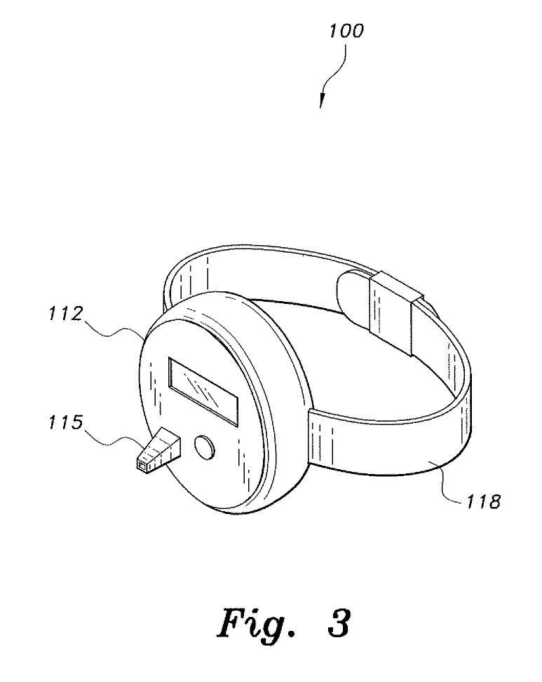

On the back of the medallion 12, the medical parameters notification system 10 includes a sensor cluster or array 22 for sensing a variety of biometric data such as heart rate, temperature, blood pressure, etc. For some of the sensing functions, the sensor cluster 22 must touch the user's skin in order to sample sweat or other fluids in order to obtain the necessary data. To insure that adequate contact is maintained, the back of the medallion 12 can, if necessary, include medical adhesive strips or tapes 20 for securing the medallion 12 onto the user's skin. Medical-grade adhesives are preferred since these types of adhesive strips adhere to the skin more securely and the adhesion does not readily degrade over time from the body oils and sweat. However, other adhesive strips and tapes with similar characteristics may also be used. As an alternative, the straps for wearing the medallion 12 may be arranged so that proper skin contact can be maintained without the medical adhesive strips 20. Some non-limiting examples are shown in FIGS. 3-5, the description of which will be further discussed below.

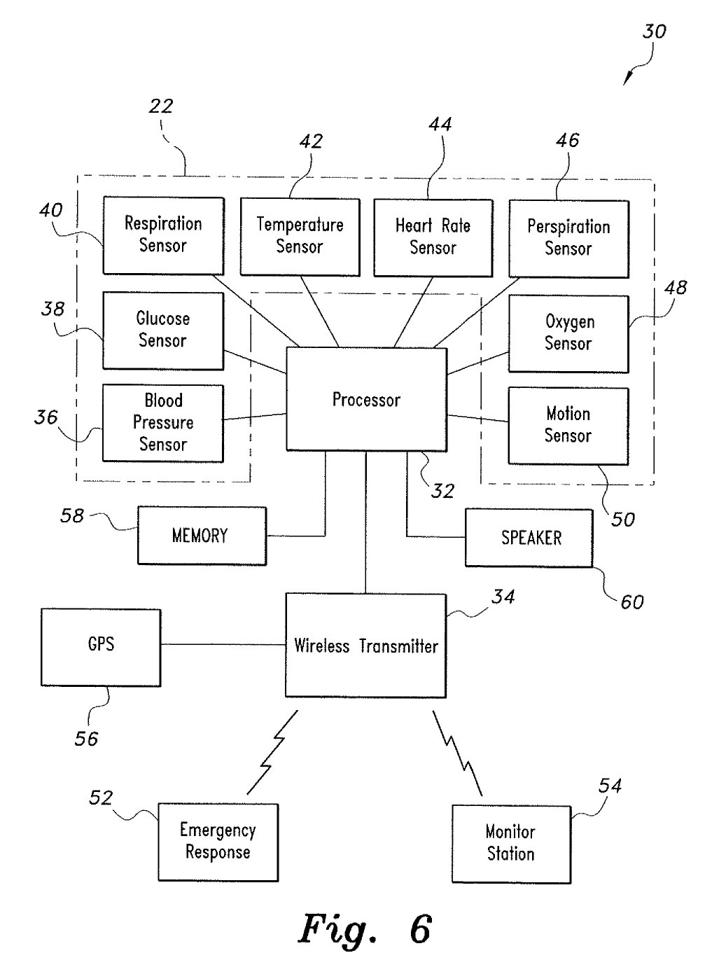

The control assembly 30 for monitoring and controlling various functions of the medical parameters notification system 10 is schematically shown in FIG. 6. The control assembly 30 includes a processor 32 that manages data from the sensor cluster 22, and power is provided by a rechargeable battery (not shown). Besides data management, the processor 32 controls the information on the display 16 and the manner in which the information is displayed. For example, if an alarm function is used for an appointment or a dose of medication, the displayed information may flash with an accompanying audible alarm vis-à-vis the speaker 60. in addition to audible alarms for appointments, the speaker 60 may be activated in emergency situations, either automatically or manually vis-à-vis the button 14, as a means of alerting anyone nearby of the emergency. The audible alarms include sounds as well as pre-recorded messages. Some non-limiting examples of audible messages may include “Help! Need assistance!” and for more routine issues, “Refill prescription” and “Time for medicine.”

The sensor cluster 22 may include the following: a blood pressure sensor 36, a glucose sensor 38, a respiration sensor 40, a temperature sensor 42, heart rate sensor 44, perspiration sensor 46, oxygen sensor 48, and a motion sensor 50. Examples of the above sensors are taught in U.S. Pat. No. 6,102,856, issued to Groff et al., U.S. Pat. No. 7,187,292, issued to Hayashi et al., U.S. Patent Application Publication 2010/0231379 to Hutzler et al., U.S. Patent Application Publication 2011/0137851 to Cavet et al., and U.S. Patent Application Publication 2011/0136158 to Takenaka et al., each of which is hereby incorporated in its entirety. These sensors generate biological data obtained from the wearer such as blood pressure levels, glucose levels, body temperature, heart rate, perspiration rate, and oxygen levels. The data from the sensor cluster 22 is stored in memory 58 and transmitted wirelessly via a wireless transmitter 34 to a monitor station 54 and/or to emergency response 52. The wireless transmission may be facilitated through cellular networks, or in areas not covered by cellular networks, a localized radio frequency network.

The majority of the biometric data is generated by the sensors 36, 38, 40, 42, 44, 46, 48 except for the motion sensor 50. The motion sensor 50 detects movements of the wearer, especially for instances of an accidental fall. Some examples of motion sensors are taught in U.S. Pat. Nos. 7,934,423 and 7,907,838, both issued to Nasiri et al., which are hereby incorporated by reference in their entirety. The motion sensor 50 includes accelerometers and/or gyroscopes that react to the wearer's movements. In a fall, the accelerometers will detect a rapid deceleration or change, which triggers a potential emergency situation. If the wearer is indeed in need of assistance, then the wearer, if able, manually presses the button 14 to notify authorities, or the medical parameters notification system 10 will automatically notify emergency response 52 when a predetermined brief period of time has passed. It is noted here that unlike typical notification systems, the emergency signal can be conducted automatically, which is paramount in situations where the user is incapable of physical movement.

As inferred above, a rapid deceleration detected by the motion sensor 50 alone may not be indicative of an emergency. There are many instances in which rapid changes can occur during normal movement or accidental bumps against an object. To counteract false alerts, the control assembly 30 is configured so that most normal movements will not trigger an alarm. Moreover, the control assembly 30 includes programmed safeguards against unnecessary notification to emergency response 52. A non-limiting example includes a notification to the wearer both visual, via the display 16, and audible message, via the speaker 60, requesting confirmation of an emergency. If the wearer does not respond within a set period of time, e.g., five minutes or less, then an emergency signal is automatically sent to emergency response 52. In the event that the system 10 is activated inadvertently and not by an emergency or fall, this countdown can be cancelled by the user with a simple press of the button 14.

In addition to detecting potential emergencies, the motion sensor 50 can also be used to monitor the wearer's physical activity. For example, most physicians recommend physical exercise as a means of maintaining one's health. In that regard, the motion sensor 50 may be used to record the amount of physical activity performed by the wearer throughout the day, and the data therefrom helps to monitor the wearer's progress.

The medical parameters notification system 10 primarily transmits the data to the monitor station 54 where comparisons and diagnosis can be performed. The monitor station 54 can be a centralized monitoring facility in a designated health care center and/or a computer of the physician in charge of the user, wearer or patient. In either situation, the normal or non-emergency medical parameters for the patient's well-being are known and/or programmed, recorded or established in the monitor station 54 or physician's computer. However, if the received data shows any deviation, then the deviation may be indicative of a potential health issue worthy of further investigation. In the non-limiting preferred embodiment, the sampling rate for the biometric data is constant. For some patients, their medical condition may not warrant such frequent monitoring. In that case, the processor 32 can be programmed to sample periodically, e.g., thirty second intervals, intervals of several minutes, or hourly. Irrespective of the sampling rate, in an emergency, the biometric data is immediately recorded and transmitted so that the information will be available to the emergency response team as well as the health care center.

The control assembly 30 may include an additional safeguard for effective emergency notification. An incapacitated wearer may not be able to provide information on the location where an accident or fall occurred. To insure that the wearer can be located, the control assembly 30 includes a GPS (global positioning system) module 56 for transmitting location data to emergency response 52 and/or monitor station 54.

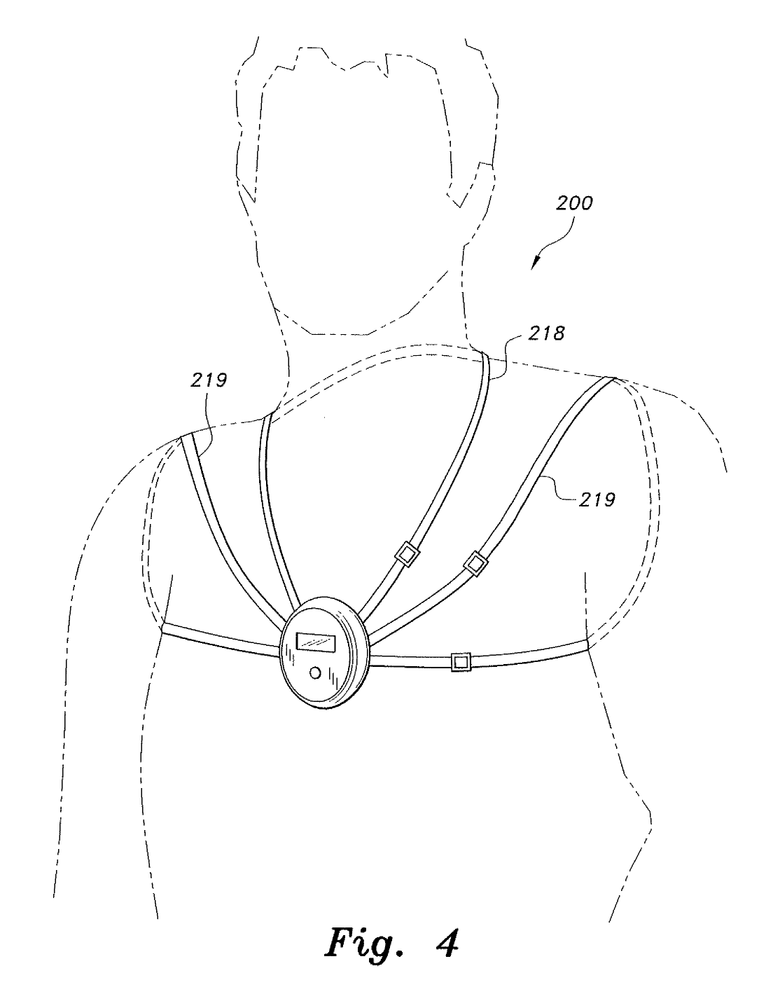

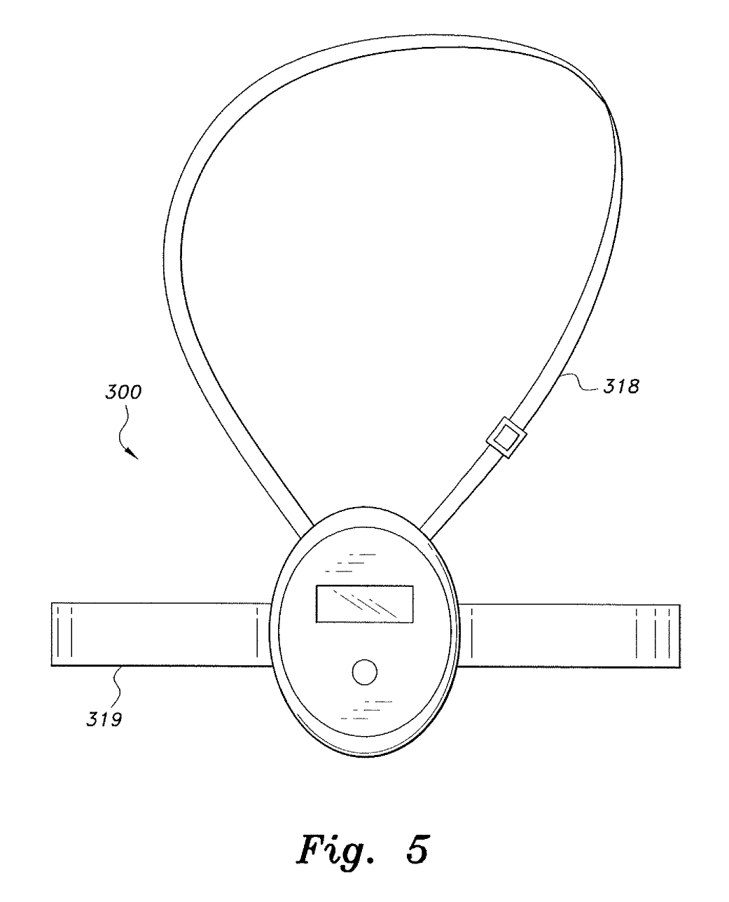

As mentioned above, the alternative embodiments and means of securing the medical parameters notification system are shown in FIGS. 3-5. In FIG. 3, the medical parameters notification system 100 includes an adjustable wrist strap 118 to be worn on the wearer's wrist. Constant skin contact can be insured in this manner. In addition, the medallion 112 may also include an air sampler/sensor for analysis of ambient content of ambient air. Air sampling can also be provided by a more direct means of providing a mouthpiece 115 for breath analysis or direct communication with the respiration sensor 40. In FIG. 4, the medical parameters notification system 200 includes an adjustable neck strap 218 and two adjustable shoulder straps 219. All three straps 218, 219 secure the medallion against the wearer's chest to ensure consistent contact with the wearer's skin. In FIG. 5, the medical parameters notification system 300 includes an adjustable neck strap 318 and a torso strap 319. As a variation to the medical parameters notification system 200, the torso strap 319 may be a more comfortable and unobtrusive fit for those who may not desire shoulder straps.

Thus, it can be seen that the medical parameters notification system 10, 100, 200, 300 provides a powerful analytical tool for preventing and responding to emergencies. The automatic alert functions relieve any concerns about the wearer's capability of manually activating the emergency signal. The breadth of biometric data that can be obtained from the sensor cluster 22 provides vital information for the emergency response team and the physician to analyze, diagnose and determine the proper treatment for the person in need.

It is to be understood that the medical parameters notification system 10, 100, 200, 300 encompasses a variety of alternatives. For example, the sensor cluster 22 is not limited to the specific sensors mentioned above. The sensor cluster 22 may comprise some or all the sensors depending on the medical condition of the wearer. Moreover, the sensor cluster 22 may be a type of assay sensor that detects certain biomarkers indicative of the presence or virulence of a specific illness or disease. Furthermore, the medical parameters notification system 10, 100, 200, 300 may be used on other subjects such as animals. In use, such a system would not utilize a button due to the normal incapacity of an animal being able to activate such a button. However, the system would be configured with more stringent safeguards against false alarms for automatic emergency notification.

It is to be understood that the present invention is not limited to the embodiments described above, but encompasses any and all embodiments within the scope of the following claims.

We claim:

1. A medical parameters notification system, comprising:
a portable device adapted to be worn on the body of a user, the portable device having a front side and a back side;
at least one connector extending from the portable device for securing the portable device on the body; and
a control assembly housed inside the portable device, the control assembly having a sensor cluster disposed on the back side of the portable device to contact the user's skin, the sensor cluster having a plurality of sensors for detecting and obtaining biometric data and having a motion sensor; and
means for wirelessly transmitting the biometric data to an emergency response and monitoring station to automatically alert medical personnel of potential emergencies.

2. The medical parameters notification system according to claim 1, further comprising at least one layer of medical tape disposed on the back side of said portable device, the at least one layer of medical tape adhering said portable device onto the body of the user to insure constant contact of said sensor cluster with the body.

3. The medical parameters notification system according to claim 1, wherein said control assembly comprises a programmable processor configured for processing data from said sensor cluster, a memory operatively connected to the processor for storage of the data, and wherein said means for wirelessly transmitting comprises a wireless transmitter connected to the processor for wireless transmission of the data.

4. The medical parameters notification system according to claim 3, further comprising a display disposed on the front side of said portable device, the display providing predefined visual information for the user.

5. The medical parameters notification system according to claim 3, further comprising a speaker operatively connected to said processor, the speaker providing predefined audible messages and inquiries for the user.

6. The medical parameters notification system according to claim 3, further comprising a GPS operatively connected to said processor, the OPS providing location data of the user.

7. The medical parameters notification system according to claim 3, wherein said plurality of sensors for detecting and obtaining biometric data comprises a blood pressure sensor, a glucose sensor, a respiration sensor, a temperature sensor, a heart rate sensor, a perspiration sensor, and an oxygen sensor.

8. The medical parameters notification system according to claim 1, wherein said portable device comprises a medallion.

9. The medical parameters notification system according to claim 1, wherein said at least one connector comprises an adjustable neck strap.

10. The medical parameters notification system according to claim 1, wherein said at least one connector comprises an adjustable wrist strap for securing said portable device on a wrist of the user.

11. The medical parameters notification system according to claim 10, further comprising a mouthpiece extending from the front side of said portable device, the mouthpiece facilitating direct breath analysis and air sampling.

12. The medical parameters notification system according to claim 1, wherein said at least one connector comprises an adjustable neck strap and a pair of adjustable shoulder straps.

13. The medical parameters notification system according to claim 1, wherein said at least one connector comprises an adjustable neck strap and an adjustable waist strap.

14. A method of monitoring biometric data of a subject, the method comprising the steps of:
providing a medical parameters notification system having:
a portable device adapted to be worn on the body of a subject, the portable device having a front side and a back side;
at least one connector extending from the portable device for securing the portable device on the body;
a control assembly housed inside the portable device, the control assembly having a sensor cluster disposed on the back side of the portable device to contact the subject's skin, the sensor cluster having a plurality of sensors for detecting and obtaining biometric data and a motion sensor; and
means for wirelessly transmitting the biometric data to an emergency response and monitoring station to automatically alert medical personnel of potential emergencies;
activating the system being worn by the subject; and
monitoring the data transmitted by the system.
